(19) United States
(12) Patent Application Publication
(10) Pub. No.: US 2025/0104925 A1
(43) Pub. Date: Mar. 27, 2025

(54) ELECTRONIC COMPONENT

(71) Applicant: TDK Corporation, Tokyo (JP)

(72) Inventors: Toshihiro Iguchi, Tokyo (JP); Masaki Hara, Tokyo (JP); Ryota Namiki, Tokyo (JP); Ayako Sato, Tokyo (JP); Kenya Tamaki, Tokyo (JP); Kazunori Oshima, Tokyo (JP)

(73) Assignee: TDK Corporation, Tokyo (JP)

(21) Appl. No.: 18/804,885

(22) Filed: Aug. 14, 2024

(30) Foreign Application Priority Data
Sep. 22, 2023 (JP) 2023-158173

(51) Int. Cl. H01G 4/38; H01G 4/012; H01G 4/248; H01G 4/30

(52) U.S. Cl. CPC H01G 4/38; H01G 4/012; H01G 4/248; H01G 4/30

(57) ABSTRACT

An electronic component includes: a substrate; a plurality of multilayer capacitors mounted on a first main surface of the substrate; and a sealing part formed of a resin and sealing the plurality of multilayer capacitors. A first external electrode and a second external electrode of the multilayer capacitor are mounted on the substrate by solder. At least a part of adjacent multilayer capacitors overlaps each other when viewed from a direction in which a pair of side surfaces of an element body are opposed to each other, the direction being along the first main surface of the substrate. In the adjacent multilayer capacitors, stacking directions of a plurality of internal electrodes are the same, and a distance between the adjacent multilayer capacitors is ½ or less of a height of the multilayer capacitor mounted on the substrate.

### TECHNICAL FIELD

The present disclosure relates to an electronic component.

### BACKGROUND

As an electronic component, an electronic component including a substrate and a plurality of multilayer capacitors mounted on the substrate is known (see, e.g., Japanese Unexamined Patent Publication No. 2023-101721). The plurality of multilayer capacitors are used, for example, for smoothing and are arranged side by side on the substrate.

### SUMMARY

When a voltage is applied to a multilayer capacitor, the multilayer capacitor may be electrostrictively deformed. In the multilayer capacitor, stress is generated in an element body due to electrostrictive deformation, and an element body may be damaged. In the multilayer capacitor, as the applied voltage is increased, the electrostrictive deformation is also increased. Therefore, in an electronic component, a voltage to be applied to a multilayer capacitor is limited, so that a high voltage cannot be applied.

An object of one aspect of the present disclosure is to provide an electronic component enabling improvement in a withstand voltage.

(1) An electronic component according to one aspect of the present disclosure includes: a substrate; a plurality of multilayer capacitors mounted on a mounting surface of the substrate; and a sealing part formed of a resin and sealing the plurality of multilayer capacitors. Each of the plurality of multilayer capacitors includes: an element body having formed a plurality of dielectric layers stacked and having a pair of end surfaces and four side surfaces coupling the pair of end surfaces; an external electrode arranged on the element body; and a plurality of internal electrodes arranged in the element body and arranged to be opposed to each other in a stacking direction of the plurality of dielectric layers, the external electrode of the multilayer capacitor being mounted on the substrate by solder. At least a part of adjacent multilayer capacitors overlaps each other when viewed from a direction in which the pair of side surfaces of the element body are opposed to each other, the direction being along the mounting surface of the substrate. In the adjacent multilayer capacitors, stacking directions of the plurality of internal electrodes are the same, and a distance between the adjacent multilayer capacitors is ½ or less of a height of the multilayer capacitor mounted on the substrate.

The electronic component according to one aspect of the present disclosure includes the sealing part that seals the plurality of multilayer capacitors. As a result, in the electronic component, electrostrictive deformation of the multilayer capacitor can be suppressed by the sealing part. In addition, in the electronic component, the multilayer capacitor is mounted (bonded) on the substrate by solder. Therefore, since in the electronic component, the multilayer capacitor is firmly bonded to the substrate, the electrostrictive deformation of the multilayer capacitor can be suppressed.

In the electronic component, when electrostrictive deformation occurs in the multilayer capacitor, the side surface of the element body is deformed. Specifically, the element body expands in a stacking direction due to electrostrictive deformation, whereby the side surfaces opposed to each other in the stacking direction are deformed (curved) into a convex shape. In addition, the side surfaces opposed to each other in a direction orthogonal to the stacking direction are deformed into a concave shape inwardly to the element body. In view of such a phenomenon, in the electronic component, at least a part of the adjacent multilayer capacitors overlaps each other when viewed from a direction in which the pair of side surfaces of the element body are opposed to each other, the direction being along the mounting surface of the substrate, and in the adjacent multilayer capacitors, the stacking directions are the same. In the electronic component, the distance between the adjacent multilayer capacitors is ½ or less of the height of the multilayer capacitor mounted on the substrate. Then, in the electronic component, the plurality of multilayer capacitors are sealed by the sealing part. The sealing part is filled between the adjacent multilayer capacitors.

As a result, when a voltage is applied to the multilayer capacitor, in each of the adjacent multilayer capacitors, a force that presses the sealing part acts by expansion, or a force that attracts the sealing part to the multilayer capacitor side acts. In the electronic component, since the stacking directions of the adjacent multilayer capacitors are the same, directions of the above forces acting in the adjacent multilayer capacitors are opposite to each other. Therefore, it is possible to suppress mutual deformation in adjacent multilayer capacitors. Therefore, since in the electronic component, electrostrictive deformation of the multilayer capacitor can be suppressed, a high voltage can be applied. As a result, in the electronic component, a withstand voltage can be improved.

(2) In the electronic component of the above (1), each of the plurality of multilayer capacitors has the same configuration, shape, and dimension, and the plurality of multilayer capacitors are arranged so as to overlap each other when viewed from the direction in which the pair of side surfaces of the element body are opposed to each other, the direction being along the mounting surface of the substrate. In this configuration, a force in the opposite direction effectively acts on the adjacent multilayer capacitor. Therefore, in the electronic component, it is possible to more reliably suppress mutual deformation in adjacent multilayer capacitors.

(3) In the electronic component of the above (1) or (2), the multilayer capacitor may be arranged so as to have the stacking direction of the plurality of internal electrodes orthogonal to the mounting surface. In this configuration, when a voltage is applied to the multilayer capacitor, a force that attracts the sealing part to the multilayer capacitor side acts in each of the adjacent multilayer capacitors. In the electronic component, since the stacking directions of the adjacent multilayer capacitors are the same, directions of the above forces acting in the adjacent multilayer capacitors are opposite to each other. Therefore, it is possible to suppress mutual deformation in adjacent multilayer capacitors.

(4) In the electronic component according to any one of the above (1) to (3), the number of the dielectric layers stacked of the multilayer capacitor may be 100 or more, and the element body may have a length in the stacking direction of 1.0 mm or more. In this configuration, the multilayer capacitor is liable to undergo electrostrictive deformation. Therefore, in a case of such a multilayer capacitor, the above configuration is particularly effective for improving a withstand voltage.

(5) In the electronic component according to any one of the above (1) to (4), a distance between the mounting surface of the substrate and the element body of the multilayer capacitor opposed to the mounting surface may be 0.2 mm or less, and the sealing part may be arranged between the mounting surface and the element body. In this configuration, since the entire multilayer capacitor is covered with the sealing part, it is possible to further suppress occurrence of electrostrictive deformation in the multilayer capacitor.

(6) In the electronic component according to any one of the above (1) to (6), the sealing part may be formed of a silicone resin or an epoxy resin. With this configuration, occurrence of electrostrictive deformation in the multilayer capacitor can be satisfactorily suppressed.

(7) In the electronic component according to any one of the above (1) to (6), a height of the sealing part from the mounting surface is twice or more a height of the multilayer capacitor mounted on the mounting surface. In this configuration, the sealing part can effectively suppress electrostrictive deformation of the plurality of multilayer capacitors.

According to one aspect of the present disclosure, a withstand voltage can be improved.

### BRIEF DESCRIPTION OF THE DRAWINGS

FIG. 1 is a perspective view of an electronic component;

FIG. 2 is a top view of the electronic component;

FIG. 3 is a side view of the electronic component;

FIG. 4 is a perspective view of a multilayer capacitor;

FIG. 5 is an exploded perspective view of the multilayer capacitor;

FIG. 6 is a cross-sectional view taken along line VI-VI in FIG. 1;

FIG. 7 is a view of the multilayer capacitor as viewed from the side;

FIG. 8 is a cross-sectional view of an electronic component according to another embodiment;

FIG. 9 is a top view of an electronic component according to a further embodiment;

FIG. 10 is a top view of an electronic component according to a still further embodiment;

FIG. 11 is a top view of an electronic component according to a still further embodiment;

FIG. 12 is a top view of an electronic component according to a still further embodiment; and

FIG. 13 is a top view of an electronic component according to a still further embodiment.

### DETAILED DESCRIPTION

In the following, preferred embodiments of the present disclosure will be described in detail with reference to the accompanying drawings. Note that, the same or corresponding elements in the description of the drawings are denoted by the same reference signs, and redundant description thereof is omitted.

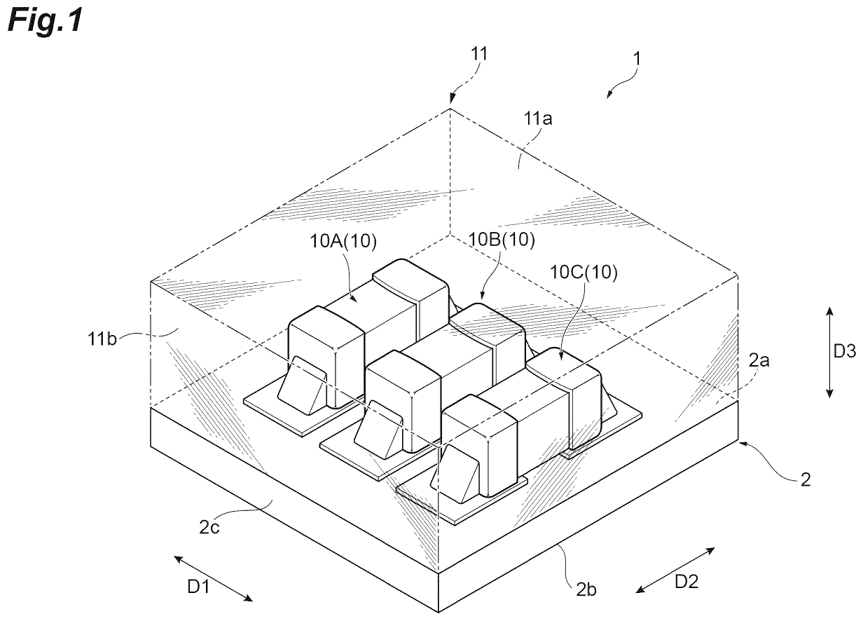

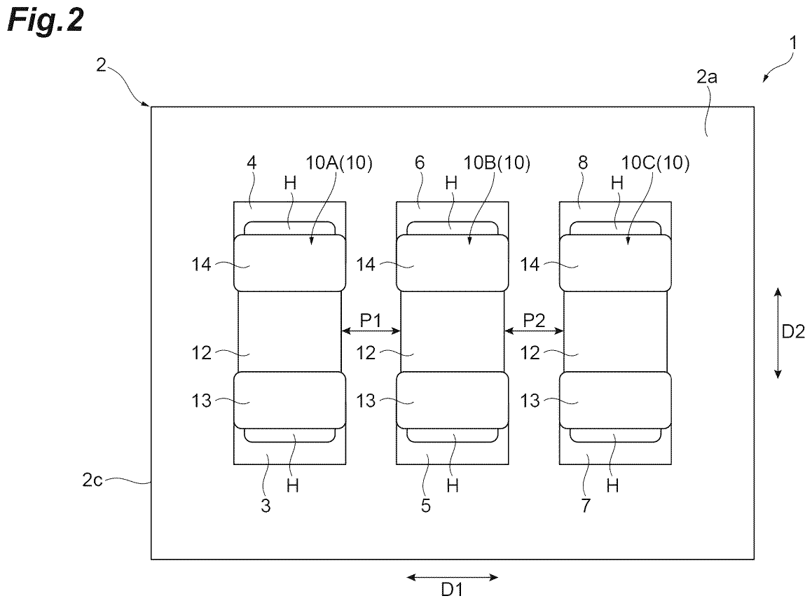

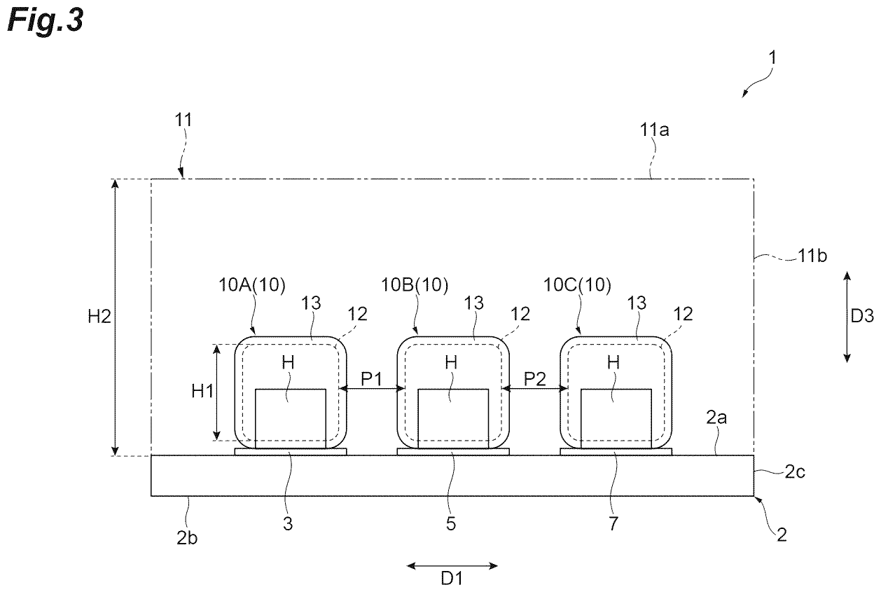

An electronic component 1 will be described with reference to FIGS. 1 to 3. FIG. 1 is a perspective view of an electronic component according to an embodiment. FIG. 2 is a top view of the electronic component. FIG. 3 is a side view of the electronic component.

As illustrated in FIGS. 1 to 3, the electronic component 1 includes a substrate 2, a plurality of multilayer capacitors 10, and a sealing part 11. The electronic component 1 may include a terminal electrode. For convenience of description, a first direction D1, a second direction D2, and a third direction D3 are set in FIG. 1. In FIG. 2, the sealing part 11 is not illustrated. In FIG. 3, the sealing part 11 is indicated by a double-dashed line.

The substrate 2 is, for example, a printed circuit board (PCB). The substrate 2 has a first main surface 2a, a second main surface 2b opposed to the first main surface 2a, and a side surface 2c connecting the first main surface 2a and the second main surface 2b. The substrate 2 has, for example, a rectangular shape when viewed from an opposing direction (third direction D3) of the first main surface 2a and the second main surface 2b. The first main surface 2a is a mounting surface on which the plurality of multilayer capacitors 10 are mounted. The second main surface 2b forms a lower surface (bottom surface) of the electronic component 1. The side surface 2c forms a side surface of the electronic component 1.

As shown in FIG. 2, the substrate 2 is provided with a first land electrode 3, a second land electrode 4, a third land electrode 5, a fourth land electrode 6, a fifth land electrode 7, and a sixth land electrode 8. The first land electrode 3, the second land electrode 4, the third land electrode 5, the fourth land electrode 6, the fifth land electrode 7, and the sixth land electrode 8 each have, for example, a rectangular shape.

The first land electrode 3, the second land electrode 4, the third land electrode 5, the fourth land electrode 6, the fifth land electrode 7, and the sixth land electrode 8 are arranged on the first main surface 2a of the substrate 2. The first land electrode 3 and the second land electrode 4 are arranged at a predetermined interval in the second direction D2. The third land electrode 5 and the fourth land electrode 6 are arranged at the predetermined interval in the second direction D2. The fifth land electrode 7 and the sixth land electrode 8 are arranged at the predetermined interval in the second direction D2.

The first land electrode 3, the third land electrode 5, and the fifth land electrode 7 are arranged at predetermined intervals in the first direction D1. The second land electrode 4, the fourth land electrode 6, and the sixth land electrode 8 are arranged at the predetermined intervals in the first direction D1.

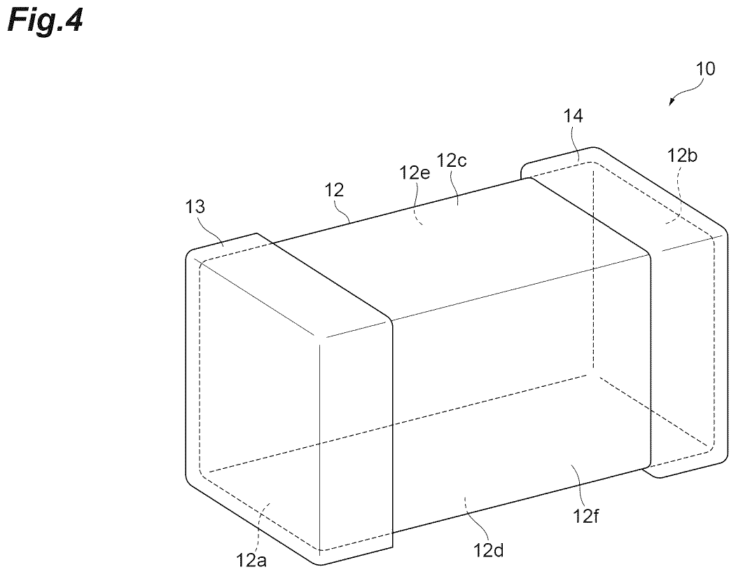

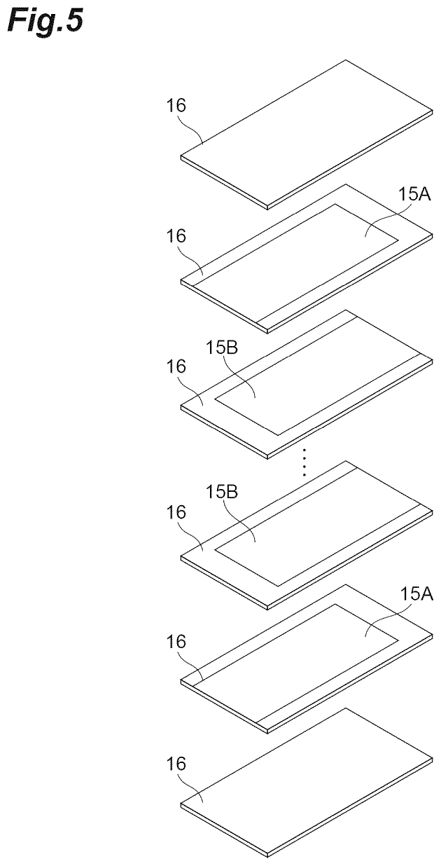

FIG. 4 is a perspective view of the multilayer capacitor 10. FIG. 5 is an exploded perspective view of the multilayer capacitor 10. As illustrated in FIGS. 4 and 5, the multilayer capacitor 10 includes an element body 12, a first external electrode 13, a second external electrode 14, and a plurality of internal electrodes 15A and 15B. In the following description, the three multilayer capacitors 10 may be distinguished as a multilayer capacitor 10A, a multilayer capacitor 10B, and a multilayer capacitor 10C in some cases. In the present embodiment, the multilayer capacitor 10A, the multilayer capacitor 10B, and the multilayer capacitor 10C have the same configuration, shape, and dimension.

The element body 12 has a rectangular parallelepiped shape. The rectangular parallelepiped shape includes a shape of a rectangular parallelepiped in which corner parts and ridge line parts are chamfered, or a shape of a rectangular parallelepiped in which corner parts and ridge line parts are rounded. The element body 12 has, as outer surfaces, a pair of end surfaces 12a and 12b, a pair of main surfaces (side surfaces) 12c and 12d, and a pair of side surfaces 12e and 12f. The end surfaces 12a and 12b are opposed to each other. The main surfaces 12c and 12d are opposed to each other. The side surfaces 12e and 12f are opposed to each other. The main surface 12d is a mounting surface, and is, for example, a surface opposed to the substrate 2 (first main surface 2a) when the multilayer capacitor 10 is mounted on the substrate 2.

As illustrated in FIG. 5, the element body 12 is formed by stacking a plurality of dielectric layers 16. In the present embodiment, for example, 100 or more dielectric layers 16 are stacked in the element body 12. A stacking direction of the dielectric layers 16 is a direction in which the pair of main surfaces 12c and 12d of the element body 12 are opposed to each other. Each dielectric layer 16 is formed by, for example, a sintered body of a ceramic green sheet containing a dielectric material. The dielectric material includes dielectric ceramic based on, for example, BaTiO₃, Ba(Ti,Zr)O₃, or (Ba,Ca)TiO₃. In the actual element body 12, the dielectric layers 16 are integrated to such an extent that boundaries between the dielectric layers 16 cannot be visually recognized.

The first external electrode 13 is arranged on the one end surface 12a side of the element body 12. The second external electrode 14 is arranged on the other end surface 12b side of the element body 12. The first external electrode 13 is arranged on the end surface 12a, a part of the main surfaces 12c and 12d, and a part of the side surfaces 12e and 12f of the element body 12. The second external electrode 14 is arranged on the end surface 12b, a part of the main surfaces 12c and 12d, and a part of the side surfaces 12e and 12f of the element body 12.

The first external electrode 13 and the second external electrode 14 are formed of a conductive material (e.g., Ni or Cu). A plating layer may be formed on surfaces of the first external electrode 13 and the second external electrode 14. The plating layer may have a layer structure including a Cu plating layer, a Ni plating layer, and a Sn plating layer, a layer structure including a Ni plating layer and a Sn plating layer, or the like.

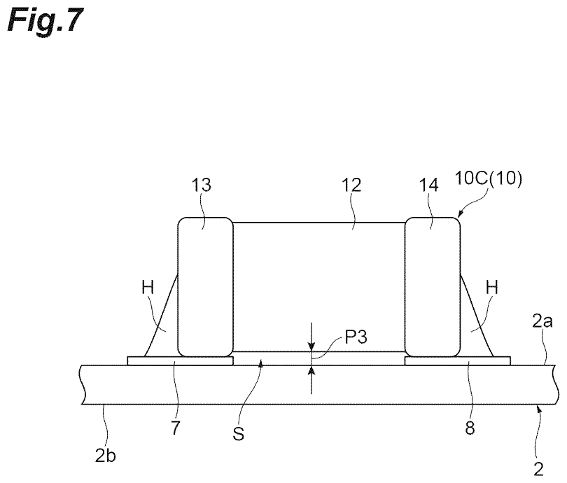

The internal electrodes 15A and 15B are arranged in the element body 12. A plurality of the internal electrodes 15A and 15B are arranged. The plurality of internal electrodes 15A are connected to the first external electrode 13. The plurality of internal electrodes 15B are connected to the second external electrode 14. The internal electrodes 15A and 15B are formed of a conductive material (e.g., Ni, Cu, or the like). Although in FIG. 7, seven internal electrodes 15A and 15B are illustrated as an example, the number of the internal electrodes 15A and 15B is not limited thereto.

As shown in FIG. 2, the multilayer capacitor 10A is arranged on the first land electrode 3 and the second land electrode 4. Specifically, the first external electrode 13 of the multilayer capacitor 10A is arranged on the first land electrode 3, and the second external electrode 14 of the multilayer capacitor 10A is arranged on the second land electrode 4. The first external electrode 13 and the first land electrode 3 are bonded by a solder H. The second external electrode 14 and the second land electrode 4 are bonded by the solder H.

The multilayer capacitor 10B is arranged on the third land electrode 5 and the fourth land electrode 6. Specifically, the first external electrode 13 of the multilayer capacitor 10B is arranged on the third land electrode 5, and the second external electrode 14 of the multilayer capacitor 10B is arranged on the fourth land electrode 6. The first external electrode 13 and the third land electrode 5 are bonded by the solder H. The second external electrode 14 and the fourth land electrode 6 are bonded by the solder H.

The multilayer capacitor 10C is arranged on the fifth land electrode 7 and the sixth land electrode 8. Specifically, the first external electrode 13 of the multilayer capacitor 10C is arranged on the fifth land electrode 7, and the second external electrode 14 of the multilayer capacitor 10C is arranged on the sixth land electrode 8. The first external electrode 13 and the fifth land electrode 7 are bonded by the solder H. The second external electrode 14 and the sixth land electrode 8 are bonded by the solder H.

The first land electrode 3, the third land electrode 5, and the fifth land electrode 7 may be one component (member). In other words, the first external electrodes 13 of the multilayer capacitor 10A, the multilayer capacitor 10B, and the multilayer capacitor 10C may be arranged in one land electrode. The second land electrode 4, the fourth land electrode 6, and the sixth land electrode 8 may be one component. In other words, the second external electrodes 14 of the multilayer capacitor 10A, the multilayer capacitor 10B, and the multilayer capacitor 10C may be arranged in one land electrode.

In addition, the first land electrode 3, the second land electrode 4, the third land electrode 5, the fourth land electrode 6, the fifth land electrode 7, and the sixth land electrode 8 may be buried in the substrate 2. For example, the first land electrode 3, the second land electrode 4, the third land electrode 5, the fourth land electrode 6, the fifth land electrode 7, and the sixth land electrode 8 may be flush with the first main surface 2a of the substrate 2.

In the present embodiment, the multilayer capacitor 10A, the multilayer capacitor 10B, and the multilayer capacitor 10C are arranged at the same position in the second direction D2. In other words, the positions of the multilayer capacitor 10A, the multilayer capacitor 10B, and the multilayer capacitor 10C in the second direction D2 are aligned. The multilayer capacitor 10A, the multilayer capacitor 10B, and the multilayer capacitor 10C overlap each other when viewed from the first direction D1 (the direction in which the pair of side surfaces 12f and 12e are opposed to each other, the direction being along the first main surface 2a of the substrate 2). In other words, the multilayer capacitor 10A, the multilayer capacitor 10B, and the multilayer capacitor 10C do not protrude in the second direction D2 when viewed from the first direction D1 or the third direction D3.

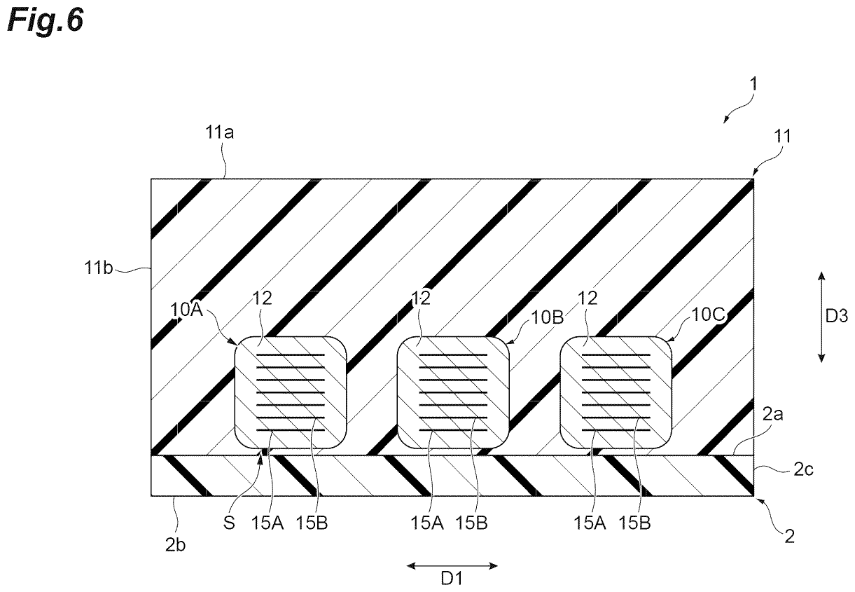

As illustrated in FIG. 6, the multilayer capacitor 10A, the multilayer capacitor 10B, and the multilayer capacitor 10C have stacking directions of the internal electrodes 15A and 15B aligned. The multilayer capacitor 10A, the multilayer capacitor 10B, and the multilayer capacitor 10C are arranged such that the stacking direction of the internal electrodes 15A and 15B is along the third direction D3. The multilayer capacitor 10A, the multilayer capacitor 10B, and the multilayer capacitor 10C are arranged such that the stacking direction of the internal electrodes 15A and 15B is orthogonal to the first main surface 2a of the substrate 2.

As illustrated in FIGS. 2 and 3, a distance P1 between the adjacent multilayer capacitor 10A and multilayer capacitor 10B is ½ (50%) or less of a height T1 of the multilayer capacitor 10 (P1≤H1/2). In the present embodiment, the distance P1 is a distance between the element body 12 of the multilayer capacitor 10A and the element body 12 of the multilayer capacitor 10B.

A distance P2 between the adjacent multilayer capacitor 10B and multilayer capacitor 10C is ½ or less of the height T1 of the multilayer capacitor 10 (P2≤H1/2). In the present embodiment, the distance P2 is a distance between the element body 12 of the multilayer capacitor 10B and the element body 12 of the multilayer capacitor 10C.

As illustrated in FIG. 3, in the present embodiment, the height T1 of the multilayer capacitor 10 is a length of the element body 12 in the third direction D3 (a distance between the pair of main surfaces 12c and 12d). The height T1 of the multilayer capacitor 10 is a height of the multilayer capacitor 10 being mounted on the substrate 2. The height T1 of the multilayer capacitor 10 is, for example, 1.0 mm or more. The height T1 of the multilayer capacitor 10 may be a length of a part having the maximum dimension in the third direction D3. For example, the height T1 of the multilayer capacitor 10 may be a length of the first external electrode 13 and the second external electrode 14 in the third direction D3.

As illustrated in FIG. 7, in the present embodiment, a space S is formed between the first main surface 2a of the substrate 2 and the element body 12 of the multilayer capacitor 10. A distance P3 between the first main surface 2a of the substrate 2 and the element body 12 of the multilayer capacitor 10 is, for example, 0.2 mm or less, and preferably 0.1 mm or less.

As illustrated in FIG. 1, the sealing part 11 seals (covers) the plurality of multilayer capacitors 10. The sealing part 11 has, for example, a substantially rectangular parallelepiped shape. The sealing part 11 is formed of a resin. In general, a resin used for potting or molding can be used. The resin is, for example, a silicone resin, an epoxy resin, or the like. The sealing part 11 may have transparency or may not have transparency (may be opaque).

The sealing part 11 is provided to protect the multilayer capacitor 10. The sealing part 11 has a function of suppressing the multilayer capacitor 10 from electrostrictively deforming. In addition, the sealing part 11 has a function of suppressing application of an external force to the multilayer capacitor 10, a function of electrically insulating the multilayer capacitor 10 from the outside, a function of protecting the multilayer capacitor 10 from dust and dirt, and the like.

The sealing part 11 has a main surface 11a and four side surfaces 11b as outer surfaces. The main surface 11a forms an upper surface of the electronic component 1. The four side surfaces 11b form side surfaces of the electronic component 1.

As illustrated in FIG. 3, a height T2 of the sealing part 11 (a distance between the first main surface 2a of the substrate 2 and the main surface 11a of the sealing part 11) is twice or more the height T1 of the multilayer capacitor 10. As illustrated in FIG. 4, the sealing part 11 is arranged (filled) in the space S between the first main surface 2a of the substrate 2 and the element body 12 of the multilayer capacitor 10.

As described in the foregoing, the electronic component 1 according to the present embodiment includes the sealing part 11 that seals the plurality of multilayer capacitors 10. As a result, in the electronic component 1, the sealing part 11 can suppress electrostrictive deformation of the multilayer capacitor 10. In addition, in the electronic component 1, the multilayer capacitor 10 is mounted (bonded) on the substrate 2 by the solder H. Therefore, in the electronic component 1, since the multilayer capacitor 10 is firmly bonded to the substrate 2, the electrostrictive deformation of the multilayer capacitor 10 can be suppressed.

In the electronic component 1, when electrostrictive deformation occurs in the multilayer capacitor 10, the main surfaces 12c and 12d and the side surfaces 12e and 12f of the element body 12 are deformed. Specifically, the element body 12 expands in the stacking direction of the internal electrodes 15A and 15B due to the electrostrictive deformation, whereby the main surfaces 12c and 12d opposed to each other in the stacking direction are deformed (curved) into a convex shape. In addition, the side surfaces 12e and 12f opposed to each other in a direction orthogonal to the stacking direction are deformed into a concave shape inwardly to the element body 12. In view of such a phenomenon, in the electronic component 1, the adjacent multilayer capacitors 10 overlap when viewed from the first direction D1, and in the adjacent multilayer capacitors 10, the stacking directions of the plurality of the internal electrodes 15A and 15B are the same. In the electronic component 1, the distances P1 and P2 between the adjacent multilayer capacitors 10 are ½ or less of the height T1 of the multilayer capacitor 10 mounted on the substrate 2. Then, in the electronic component 1, the plurality of multilayer capacitors 10 are sealed by the sealing part 11. The sealing part 11 is filled between the adjacent multilayer capacitors 10.

In the electronic component 1 according to the present embodiment, the multilayer capacitor 10 is arranged such that the stacking direction of the plurality of internal electrodes 15A and 15B is orthogonal to the first main surface 2a (mounting surface) of the substrate 2. In this configuration, when a voltage is applied to the multilayer capacitor 10, a force that attracts the sealing part 11 to the multilayer capacitor 10 side acts in each of the adjacent multilayer capacitors 10. In the electronic component 1, since the above stacking directions of the adjacent multilayer capacitors 10 are the same, directions of the above forces acting in the adjacent multilayer capacitors 10 are opposite to each other. Therefore, it is possible to suppress mutual deformation in the adjacent multilayer capacitors 10. Therefore, since in the electronic component 1, the electrostrictive deformation of the multilayer capacitor 10 can be suppressed, a high voltage can be applied. As a result, the electronic component 1 enables improvement of a withstand voltage.

In the electronic component 1 according to the present embodiment, the number of stacked dielectric layers 16 of the multilayer capacitor 10 is 100 or more. In the multilayer capacitor 10, a length of the element body 12 in a stacking direction thereof (a direction in which the pair of main surfaces 12c and 12d are opposed to each other) is 1.0 mm or more. In this configuration, the multilayer capacitor 10 is liable to undergo electrostrictive deformation. Therefore, in a case of such a multilayer capacitor 10, the above configuration is particularly effective for improving a withstand voltage.

In the electronic component 1 according to the present embodiment, a distance between the first main surface 2a of the substrate 2 and the main surface 12d of the element body 12 of the multilayer capacitor 10 is 0.2 mm or less. In the electronic component 1, the sealing part 11 is arranged between the first main surface 2a of the substrate 2 and the main surface 12d of the element body 12. In this configuration, since the entire multilayer capacitor 10 is covered with the sealing part 11, it is possible to further suppress occurrence of electrostrictive deformation in the multilayer capacitor 10.

In the electronic component 1 according to the present embodiment, the sealing part 11 is formed of a silicone resin or an epoxy resin. With this configuration, occurrence of electrostrictive deformation in the multilayer capacitor 10 can be satisfactorily suppressed.

In the electronic component 1 according to the present embodiment, the height T2 of the sealing part 11 from the first main surface 2a of the substrate 2 is twice or more the height T1 of the multilayer capacitor 10 mounted on the first main surface 2a of the substrate 2. In this configuration, the sealing part 11 can effectively suppress the electrostrictive deformation of the plurality of multilayer capacitors 10.

Although the embodiment of the present disclosure has been described in the foregoing, the present disclosure is not necessarily limited to the above-described embodiment, and various modifications can be made without departing from the gist thereof.

In the above embodiment, the mode in which the substrate 2 has a rectangular shape has been described as an example. However, the shape of the substrate 2 is not limited thereto.

In the above embodiment, the mode in which the sealing part 11 has a substantially rectangular shape has been described as an example. However, the shape of the sealing part 11 is not limited thereto.

In the above embodiment, the description has been made, as an example, of the mode in which the first external electrode 13 and the second external electrode 14 have the configurations illustrated in FIG. 4. However, the configurations of the first external electrode 13 and the second external electrode 14 are not limited thereto, and may have, for example, an L shape.

In the above embodiment, the description has been made, as an example, of the mode in which the multilayer capacitor 10A, the multilayer capacitor 10B, and the multilayer capacitor 10C have the same configuration, shape, and dimension. However, the multilayer capacitor 10A, the multilayer capacitor 10B, and the multilayer capacitor 10C may have different configurations. In this case, the distances P1 and P2 are set on the basis of the multilayer capacitor 10 having the largest height T1.

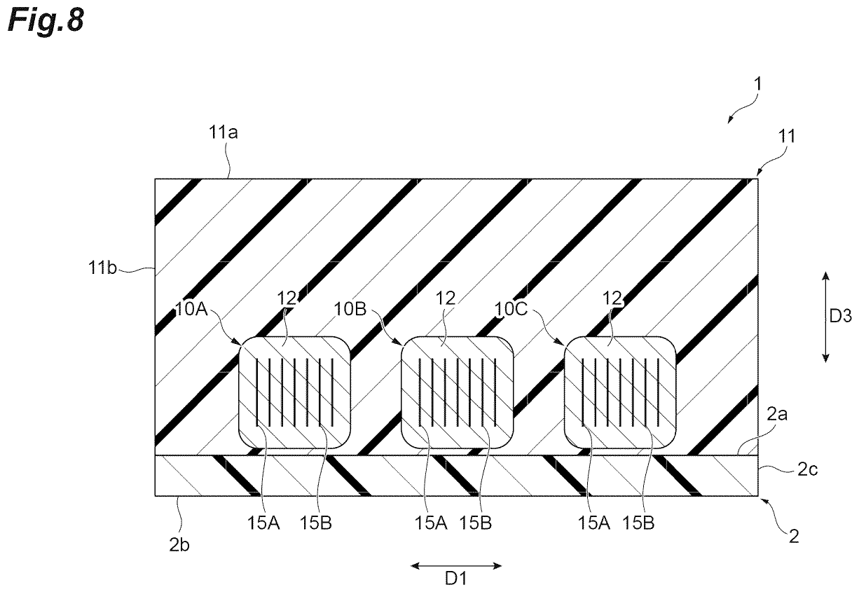

In the above embodiment, as an example, the description has been made of the mode in which the multilayer capacitor 10A, the multilayer capacitor 10B, and the multilayer capacitor 10C are arranged such that the stacking direction of the internal electrodes 15A and 15B is along the third direction D3. In other words, as an example, the description has been made of the mode in which the multilayer capacitor 10A, the multilayer capacitor 10B, and the multilayer capacitor 10C are arranged such that the stacking direction of the internal electrodes 15A and 15B is orthogonal to the first main surface 2a of the substrate 2. However, as illustrated in FIG. 8, the multilayer capacitor 10A, the multilayer capacitor 10B, and the multilayer capacitor 10C may be arranged such that the stacking direction of the internal electrodes 15A and 15B is along the first direction D1.

In this configuration, when a voltage is applied to the multilayer capacitor 10, a force that presses the sealing part 11 by expansion acts in each of the adjacent multilayer capacitors 10. In the electronic component 1, since the stacking directions of the adjacent multilayer capacitors 10 are the same, directions of the above forces acting in the adjacent multilayer capacitors 10 are opposite to each other. Therefore, it is possible to suppress mutual deformation in the adjacent multilayer capacitors 10. Therefore, since in the electronic component 1, the electrostrictive deformation of the multilayer capacitor 10 can be suppressed, a high voltage can be applied. As a result, the electronic component 1 enables improvement of a withstand voltage.

In the above embodiment, the mode in which the multilayer capacitor 10A, the multilayer capacitor 10B, and the multilayer capacitor 10C are arranged at the same position in the second direction D2 has been described as an example. In other words, as an example, the description has been made of the mode in which the positions of the multilayer capacitor 10A, the multilayer capacitor 10B, and the multilayer capacitor 10C in the second direction D2 are aligned. However, the arrangement of the multilayer capacitor 10A, the multilayer capacitor 10B, and the multilayer capacitor 10C is not limited thereto.

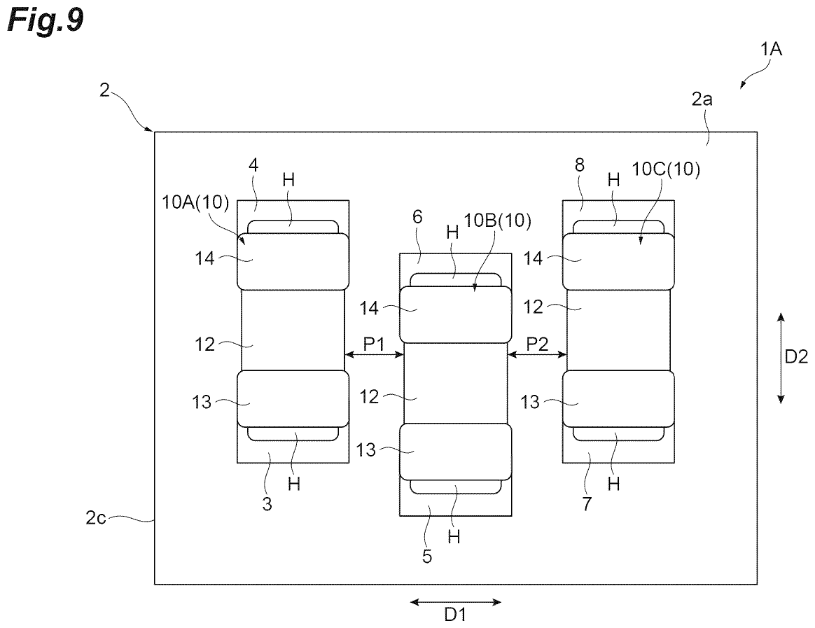

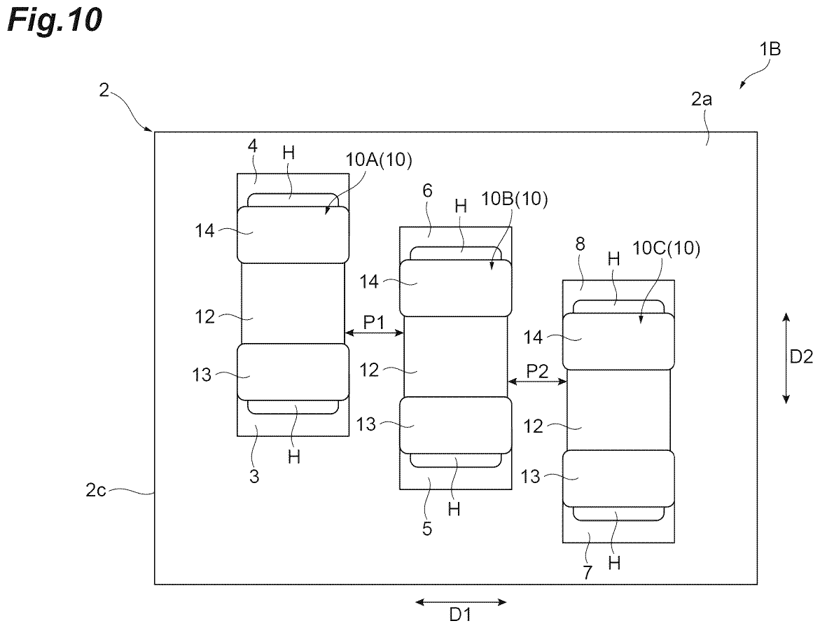

As illustrated in FIG. 9, in an electronic component 1A, the multilayer capacitor 10A, the multilayer capacitor 10B, and the multilayer capacitor 10C may be arranged in a zigzag manner. As illustrated in FIG. 10, in an electronic component 1B, the multilayer capacitor 10A, the multilayer capacitor 10B, and the multilayer capacitor 10C may be arranged in a stepwise shifted manner in the second direction D2.

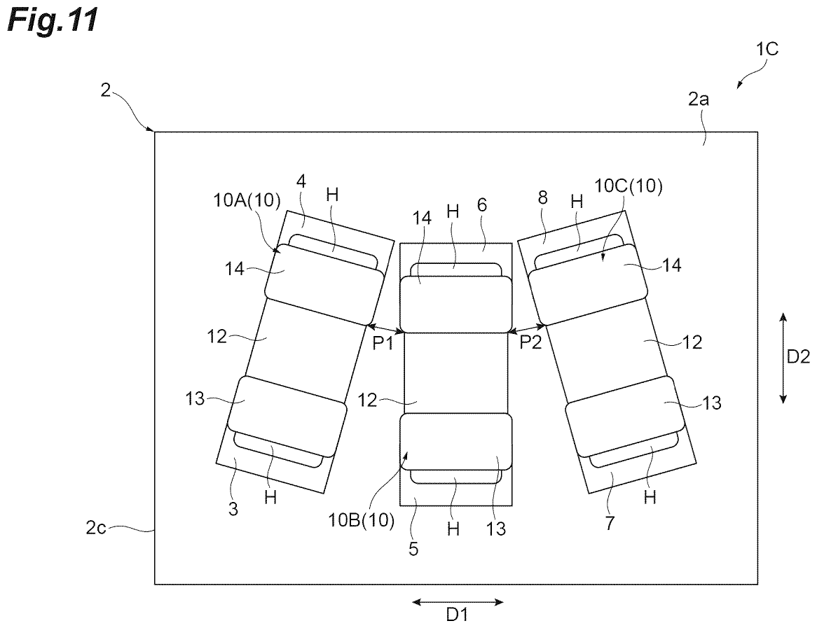

As illustrated in FIG. 11, in an electronic component 1C, the multilayer capacitor 10A, the multilayer capacitor 10B, and the multilayer capacitor 10C may be arranged such that an interval between the adjacent multilayer capacitors 10A, 10B, and 10C is not constant (such that the intervals are different). In this configuration, the distance P1 is the shortest distance between the multilayer capacitor 10A and the multilayer capacitor 10B. The distance P2 is the shortest distance between the multilayer capacitor 10B and the multilayer capacitor 10C.

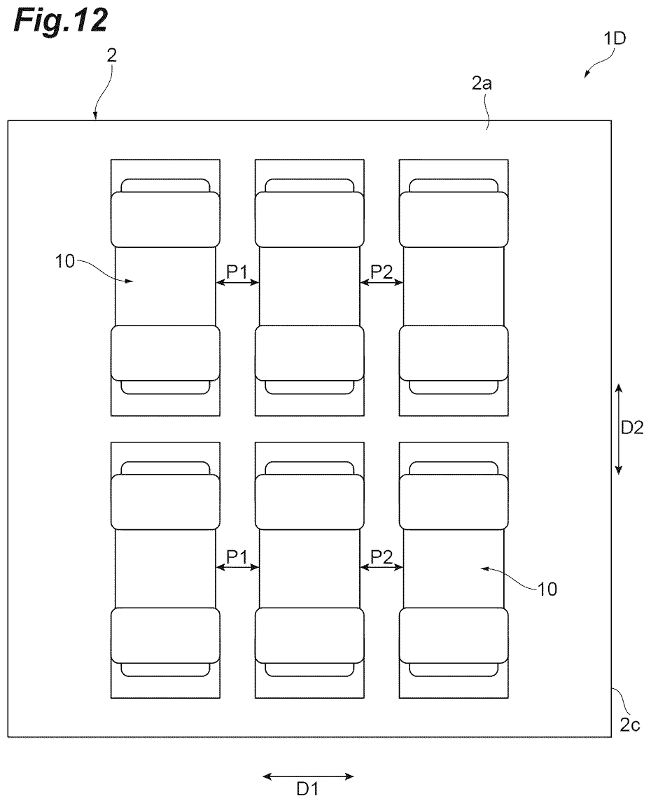

In the above embodiment, the mode in which three multilayer capacitors 10 are mounted has been described as an example. However, the number of multilayer capacitors 10 in the electronic component is not limited thereto. In the electronic component, the number of mounted multilayer capacitors 10 may be two or four or more. As illustrated in FIG. 12, in an electronic component 1D, six multilayer capacitors 10 are mounted. In the electronic component 1D, three multilayer capacitors 10 juxtaposed in the first direction D1 are arranged in two rows in the second direction D2.

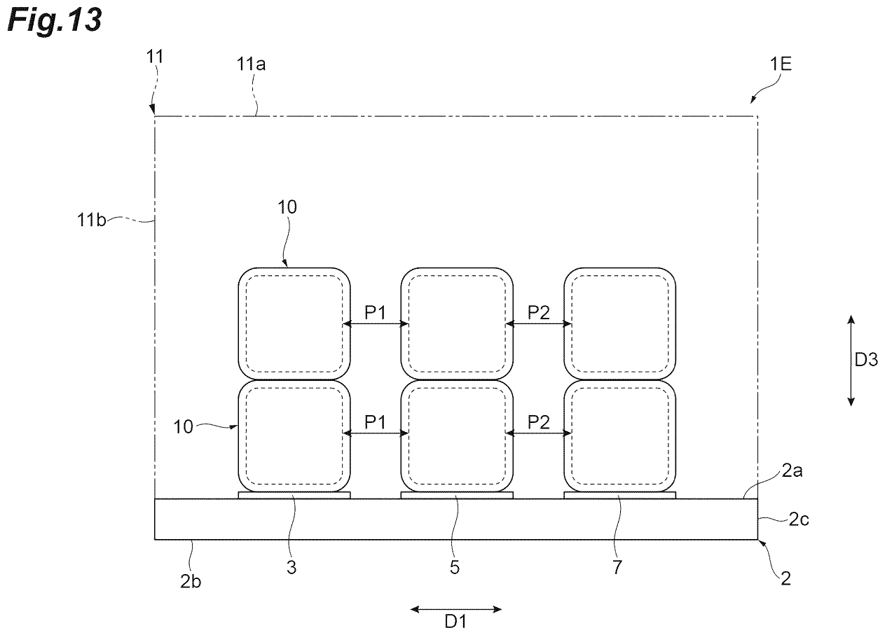

In addition to the above embodiments, as illustrated in FIG. 13, in an electronic component 1E, for example, two multilayer capacitors 10 may be arranged to overlap each other in the third direction D3. In the two multilayer capacitors 10 arranged in an overlapping manner, the first external electrodes 13 are electrically connected to each other, and the second external electrodes 14 are electrically connected to each other by a bonding member (conductive adhesive material, solder) or the like.

### EXAMPLES

Although in the following, the present invention will be described more specifically on the basis of Examples and Comparative Examples, the present invention is not limited to the following Examples.

### <Production of Electronic Component>

(Example 1) As an element body of a multilayer capacitor, an element body having a length L (a distance between a pair of end surfaces) of 3.2 mm, a width W (a distance between a pair of side surfaces) of 2.5 mm, and a height T (a distance between a pair of main surfaces) of 2.5 mm was used. A dielectric layer forming the element body of the multilayer capacitor has a thickness of 4.9 μm. In an internal electrode, a distance (L-Gap) to the end surface is 196 μm, and a distance (W-Gap) to the side surface is 180 μm. A first external electrode and a second external electrode were formed by forming a baked layer of Cu and applying Ni/Sn plating on the baked layer.

The above multilayer capacitor was mounted on a glass epoxy substrate by Sn—Ag—Cu solder. In the electronic component according to Example 1, three multilayer capacitors were mounted. The three multilayer capacitors were electrically connected in parallel. The multilayer capacitor was arranged such that a stacking direction of a plurality of the internal electrodes was orthogonal to a mounting surface of the substrate. As shown in FIG. 2, the three multilayer capacitors were arranged such that the directions of the lengths L of the element bodies were aligned. A distance between adjacent multilayer capacitors was set to 45% of the height of the element body. A distance between the element body of the multilayer capacitor and the substrate was set to 0.1 mm. The multilayer capacitor was sealed with a silicone resin to form a sealing part. A height of the sealing part was set to 2.1 times the height of the element body. In the foregoing manner, the electronic component according to Example 1 was obtained.

(Example 2) An electronic component according to Example 2 was obtained by producing an electronic component in the same manner as in Example 1 except that the height of the sealing part was set to 1.5 times the height of the element body.

(Example 3) An electronic component according to Example 3 was obtained by producing an electronic component in the same manner as in Example 1 except that the height of the sealing part was set to 1.5 times the height of the element body and that the sealing part was formed of an epoxy resin.

(Example 4) An electronic component according to Example 4 was obtained by producing an electronic component in the same manner as in Example 1 except that the multilayer capacitor was arranged such that the stacking direction of the plurality of internal electrodes was horizontal to the mounting surface of the substrate as shown in FIG. 8, and that the height of the sealing part was set to 1.5 times the height of the element body.

(Example 5) An electronic component according to Example 5 was obtained by producing an electronic component in the same manner as in Example 1 except that two multilayer capacitors were used.

(Example 6) An electronic component according to Example 6 was obtained by producing an electronic component in the same manner as in Example 1 except that two multilayer capacitors were used and that the height of the sealing part was set to 1.5 times the height T of the element body.

(Example 7) An electronic component according to Example 7 was obtained by producing an electronic component in the same manner as in Example 1 except that the multilayer capacitor and the substrate were bonded via a connection member (metal terminal) to have the distance between the element body of the multilayer capacitor and the substrate set to 0.8 mm, and that the height of the sealing part was set to 1.5 times the height of the element body.

(Comparative Example 1) An electronic component according to Comparative Example 1 was obtained by producing an electronic component in the same manner as in Example 1 except that no sealing part was provided.

(Comparative Example 2) An electronic component according to Comparative Example 2 was obtained by producing an electronic component in the same manner as in Example 1 except that the distance between adjacent multilayer capacitors was set to 70% of the height of the element body, and that the height of the sealing part was set to 1.5 times the height T of the element body.

(Comparative Example 3) An electronic component according to Comparative Example 3 was obtained by producing an electronic component in the same manner as in Example 1 except that two multilayer capacitors among the three multilayer capacitors were arranged such that the stacking direction of the plurality of internal electrodes was orthogonal to the mounting surface of the substrate, that a stacking direction of one multilayer capacitor arranged between the two multilayer capacitors was arranged such that the stacking direction of the plurality of internal electrodes was horizontal to the mounting surface of the substrate, and that the height of the sealing part was set to 1.5 times the height T of the element body.

(Comparative Example 4) An electronic component according to Comparative Example 4 was obtained by producing an electronic component in the same manner as in Example 1 except that one multilayer capacitor is mounted and that the height of the sealing part was set to 1.5 times the height T of the element body.

### <Measurement Method>

With a voltage set to 10 V/sec and a threshold of a current set to 10 mA, a voltage at which the electronic component was damaged was measured. For each of the electronic components according to Examples 1 to 7 and Comparative Examples 1 to 4, ten voltages were measured, and a median value of the voltages was taken as a breakdown voltage. Measurement results are shown in Table 1.

TABLE 1

| | | | | | distance | | |
|---|---|---|---|---|---|---|---|
| | the number | | | | between | | |
| | of | stacking | distance | | mounting | | |
| | multilayer | direction of | between | | surface and | | |
| | capacitors | internal | multilayer | height of | element | resin of | breakdown |
| | mounted | electrode | capacitors | sealing part | body [mm] | sealing part | voltage [V] |
| Example 1 | 3 | orthogonal | 45% of | 2.1 times | 0.1 | silicone | 354 |
| | | to mounting | height of | the height | | | |
| | | surface | element | of element | | | |
| | | | body | body | | | |
| Example 2 | 3 | orthogonal | 45% of | 1.5 times | 0.1 | silicone | 322 |
| | | to mounting | height of | the height | | | |
| | | surface | element | of element | | | |
| | | | body | body | | | |
| Example 3 | 3 | orthogonal | 45% of | 1.5 times | 0.1 | epoxy | 323 |
| | | to mounting | height of | the height | | | |
| | | surface | element | of element | | | |
| | | | body | body | | | |
| Example 4 | 3 | horizontal to | 45% of | 1.5 times | 0.1 | silicone | 333 |
| | | mounting | height of | the height | | | |
| | | surface | element | of element | | | |
| | | | body | body | | | |
| Example 5 | 2 | orthogonal | 45% of | 2.1 times | 0.1 | silicone | 340 |
| | | to mounting | height of | the height | | | |
| | | surface | element | of element | | | |
| | | | body | body | | | |
| Example 6 | 2 | orthogonal | 45% of | 1.5 times | 0.1 | silicone | 328 |
| | | to mounting | height of | the height | | | |
| | | surface | element | of element | | | |
| | | | body | body | | | |
| Example 7 | 3 | orthogonal | 45% of | 1.5 times | 0.8 | silicone | 313 |
| | | to mounting | height of | the height | | | |
| | | surface | element | of element | | | |
| | | | body | body | | | |
| Comparative | 3 | orthogonal | 45% of | 1.5 times | 0.1 | silicone | 291 |
| Example 1 | | to mounting | height of | the height | | | |
| | | surface | element | of element | | | |
| | | | body | body | | | |
| Comparative | 3 | orthogonal | 70% of | 1.5 times | 0.1 | silicone | 287 |
| Example 2 | | to mounting | height of | the height | | | |
| | | surface | element | of element | | | |
| | | | body | body | | | |
| Comparative | 3 | orthogonal | 45% of | 1.5 times | 0.1 | silicone | 286 |
| Example 3 | | to mounting | height of | the height | | | |
| | | surface | element | of element | | | |
| | | | body | body | | | |
| Comparative | 1 | orthogonal | 45% of | 1.5 times | 0.1 | silicone | 296 |
| Example 4 | | to mounting | height of | the height | | | |
| | | surface | element | of element | | | |
| | | | body | body | | | |

In the electronic component, a breakdown voltage required as a withstand voltage is 300 V or more, preferably 320 V, and more preferably 340 V or more. As shown in Table 1, in all of the electronic components according to Examples 1 to 7, the breakdown voltages were 300 V or more. In all of the electronic components according to Comparative Examples 1 to 4, the breakdown voltages were less than 300 V. As described in the foregoing, in the electronic components according to Examples 1 to 7, it was confirmed that the withstand voltage could be improved.

What is claimed is:

1. An electronic component comprising:
a substrate;
a plurality of multilayer capacitors mounted on a mounting surface of the substrate; and
a sealing part formed of a resin and sealing the plurality of multilayer capacitors, wherein each of the plurality of multilayer capacitors includes:
an element body having formed a plurality of dielectric layers stacked and having a pair of end surfaces and four side surfaces coupling the pair of end surfaces;
an external electrode arranged on the element body; and
a plurality of internal electrodes arranged in the element body and arranged to be opposed to each other in a stacking direction of the plurality of dielectric layers,
the external electrode of the multilayer capacitor being mounted on the substrate by solder, and wherein
at least a part of adjacent multilayer capacitors overlaps each other when viewed from a direction in which the pair of side surfaces of the element body are opposed to each other, the direction being along the mounting surface of the substrate,
in the adjacent multilayer capacitors, stacking directions of the plurality of internal electrodes are the same, and
a distance between the adjacent multilayer capacitors is ½ or less of a height of the multilayer capacitor mounted on the substrate.

2. The electronic component according to claim 1, wherein each of the plurality of multilayer capacitors has the same configuration, shape, and dimension, and
the plurality of multilayer capacitors are arranged so as to overlap each other when viewed from the direction in which the pair of side surfaces of the element body are opposed to each other, the direction being along the mounting surface of the substrate.

3. The electronic component according to claim 1, wherein the multilayer capacitor is arranged so as to have the stacking direction of the plurality of internal electrodes orthogonal to the mounting surface.

4. The electronic component according to claim 1, wherein the number of the dielectric layers stacked of the multilayer capacitor is 100 or more, and
the element body has a length in the stacking direction of 1.0 mm or more.

5. The electronic component according to claim 1, wherein a distance between the mounting surface of the substrate and the element body of the multilayer capacitor opposed to the mounting surface is 0.2 mm or less, and
the sealing part is arranged between the mounting surface and the element body.

6. The electronic component according to claim 1, wherein the resin is a silicone resin or an epoxy resin.

7. The electronic component according to claim 1, wherein a height of the sealing part from the mounting surface is twice or more a height of the multilayer capacitor mounted on the mounting surface.
